(19) United States
(12) Patent Application Publication
(10) Pub. No.: US 2024/0337784 A1
(43) Pub. Date: Oct. 10, 2024

(54) OPTICAL WAVEGUIDE DEVICE AND ELECTRONIC EQUIPMENT

(71) Applicant: AAC OPTICS (CHANGZHOU) CO., LTD., Changzhou City (CN)

(72) Inventor: Biming Zhang, Changzhou (CN)

(21) Appl. No.: 18/533,246

(22) Filed: Dec. 8, 2023

Related U.S. Application Data
(63) Continuation of application No. PCT/CN2023/086814, filed on Apr. 7, 2023.

(51) Int. Cl. F21V 8/00; G02B 6/122

(52) U.S. Cl. CPC G02B 6/0031; G02B 6/0016; G02B 6/0035; G02B 6/122

(57) ABSTRACT

The present disclosure provides an optical waveguide device and an electronic equipment. The optical waveguide device includes: a waveguide layer, in-coupler gratings and out-coupler gratings arranged on a same side of the waveguide layer, a reflection layer formed on a side of the in-coupler gratings away from the waveguide layer; and a transition layer formed between the reflection layer and the in-coupler gratings. The transition layer is used to address the problem that the reflection layer is prone to detachment.

### CROSS REFERENCE TO RELATED APPLICATIONS

The present application is a continuation of PCT Patent Application No. PCT/CN2023/086814, filed Apr. 7, 2023, which is incorporated by reference herein in its entirety.

### TECHNICAL FIELD

The present disclosure relates to the field of optical equipment technology, and in particular to an optical waveguide device and electronic equipment.

### BACKGROUND

An optical waveguide device is a medium device that guides the propagation of light through it, and can transmit light waves from one position to another.

As shown in FIG. 1, an existing optical waveguide device includes a waveguide layer and in-coupler gratings and out-coupler gratings arranged on the waveguide layer. After being coupled by the in-coupler gratings, light from a light source propagates in the waveguide layer by total reflection, propagates to the out-coupler gratings and is coupled out by the out-coupler gratings. In this way, the light wave can be transmitted from one position to another. In order to improve the optical efficiency of optical waveguides, in related technologies, a reflection layer (such as Ag) is plated on the in-coupler gratings. However, the insufficient bonding force between the reflection layer and the in-coupler gratings (such as titanium oxide) results in the reflection layer being prone to detachment.

### SUMMARY

The present disclosure aims to provide an optical waveguide device and electronic equipment, in order to address the problem that the metal reflection layer is prone to detachment.

The technical solutions of the present disclosure are described below.

An optical waveguide device, including: a waveguide layer; in-coupler gratings and out-coupler gratings arranged on a same side of the waveguide layer; a reflection layer formed on a side of the in-coupler gratings away from the waveguide layer; and a transition layer formed between the reflection layer and the in-coupler gratings.

The present disclosure further provides an electronic equipment including the optical waveguide device as described above.

The present disclosure has the following beneficial effects: the transition layer is added between the reflection layer and the in-coupler gratings, and the problem that the reflection layer is prone to detachment can be addressed by the transition layer.

### BRIEF DESCRIPTION OF DRAWINGS

FIG. 1 is a structural schematic diagram of an optical waveguide device in the related technologies.

FIG. 2 is a structural schematic diagram of the optical waveguide device according to some embodiments of the present disclosure.

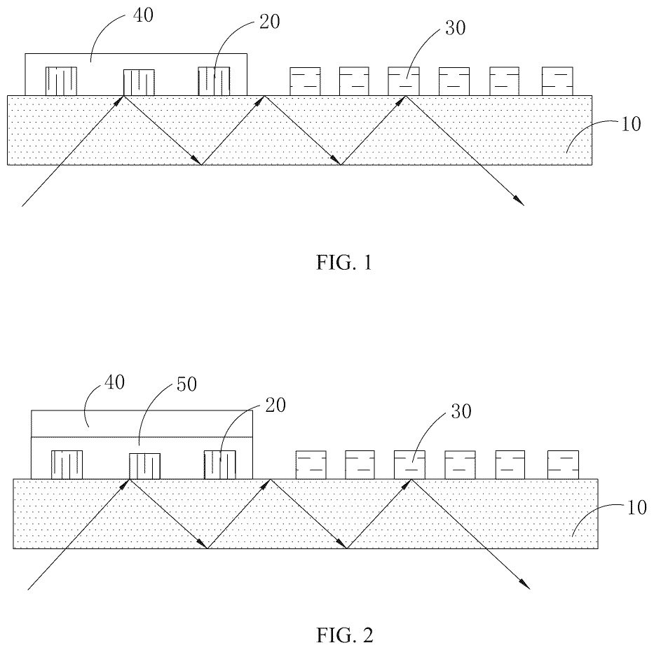

### DETAILED DESCRIPTION OF EMBODIMENTS

The following will provide, in conjunction with the accompanying drawings and the embodiments of the present disclosure, detailed description of the present disclosure.

Referring to FIG. 2, the present disclosure discloses an optical waveguide device, including: a waveguide layer 10, in-coupler gratings 20 and out-coupler gratings 30 arranged on a same side of the waveguide layer 10, a reflection layer 40 formed on a side of the in-coupler gratings 20 away from the waveguide layer 10, and a transition layer 50 formed between the reflection layer 40 and the in-coupler gratings 20. The transition layer 50 is used to address the problem that the reflection layer 40 is prone to detachment.

In some embodiments, a bonding force between the transition layer 50 and the reflection layer 40 is greater than a bonding force between the reflection layer 40 and the in-coupler gratings 20, and a bonding force between the transition layer 50 and the in-coupler gratings 20 is greater than the bonding force between the reflection layer 40 and the in-coupler gratings 20. By adding the transition layer 50, the problem that the reflection layer 40 is prone to detachment can be addressed.

In some embodiments, the transition layer 50 is a transparent layer and allows light to pass through. The total reflection of light occurs at the interface between the transition layer 50 and the reflection layer 40, and the transparent layer is configured to not affect the propagation direction of light as much as possible.

In some embodiments, the transition layer 50 may include an oxide layer. The oxide layer may include an aluminum oxide layer and/or a silicon oxide layer, or the like.

In some embodiments, a thickness of the transition layer 50 ranges from 10 nm to 50 nm.

In some embodiments, the reflection layer 40 may be a metal reflection layer, for example an Ag reflection layer, an Al reflection layer, or the like. In some other embodiments, the reflection layer 40 also may be a resin reflection layer.

In some embodiments, a material of the in-coupler gratings 20 includes one or more than two of titanium oxide (TiO_{X}), hafnium oxide (HfO_{X}), lithium niobate (LiNbO₃), titanium silicon oxide (TiSiO_{X}), silicon carbide (SiC), zinc selenide (ZnSe), indium gallium arsenic (InGaAs), and gallium phosphide (GaP).

In some embodiments, the material of the in-coupler gratings 20 is titanium oxide, the reflection layer 40 is an Ag reflection layer or an Al reflection layer, and the transition layer 50 may be one or more than two of an aluminum oxide layer, a silicon oxide layer, a silicon carbide layer, and silicon nitride layer. A bonding force between the transition layer 50 of above-mentioned materials and the reflection layer 40 of Ag or Al material is stronger, thereby addressing the problem that the reflection layer 40 of Ag or Al material is prone to detachment. The thickness of the transition layer 50 may range from 10 nm to 50 nm.

The present disclosure further discloses an electronic equipment including the optical waveguide device as described above. The electronic equipment may include close-eye display devices, projection display devices, camera devices, and the like.

The above mentioned are only the embodiments of the present disclosure. It should be pointed out that for those skilled in the art, improvements can be made without departing from the inventive concept of the present disclosure, but these improvements are all within the scope of protection of the present disclosure.

What is claimed is:

1. An optical waveguide device, comprising:
a waveguide layer;
in-coupler gratings and out-coupler gratings arranged on a same side of the waveguide layer;
a reflection layer formed on a side of the in-coupler gratings away from the waveguide layer; and
a transition layer formed between the reflection layer and the in-coupler gratings.

2. The optical waveguide device according to claim 1, wherein a bonding force between the transition layer and the reflection layer is greater than a bonding force between the reflection layer and the in-coupler gratings, and a bonding force between the transition layer and the in-coupler gratings is greater than the bonding force between the reflection layer and the in-coupler gratings.

3. The optical waveguide device according to claim 1, wherein the transition layer is a transparent layer.

4. The optical waveguide device according to claim 3, wherein the transition layer includes an oxide layer.

5. The optical waveguide device according to claim 1, wherein the transition layer includes at least one of an aluminum oxide layer or a silicon oxide layer.

6. The optical waveguide device according to claim 5, wherein a thickness of the transition layer ranges from 10 nm to 50 nm.

7. The optical waveguide device according to claim 5, wherein the reflection layer is a metal reflection layer or a resin reflection layer.

8. The optical waveguide device according to claim 7, wherein the metal reflection layer is an Ag reflection layer or an Al reflection layer.

9. The optical waveguide device according to claim 1, wherein a material of the in-coupler gratings includes one or more than two of titanium oxide, hafnium oxide, lithium niobate, titanium silicon oxide, silicon carbide, zinc selenide, indium gallium arsenic, and gallium phosphide.

10. The optical waveguide device according to claim 4, wherein the transition layer includes at least one of an aluminum oxide layer or a silicon oxide layer.

11. An electronic equipment, comprising an optical waveguide device, wherein the optical waveguide device includes:
a waveguide layer;
in-coupler gratings and out-coupler gratings arranged on a same side of the waveguide layer;
a reflection layer formed on a side of the in-coupler gratings away from the waveguide layer; and
a transition layer formed between the reflection layer and the in-coupler gratings.

12. The electronic equipment according to claim 11, wherein a bonding force between the transition layer and the reflection layer is greater than a bonding force between the reflection layer and the in-coupler gratings, and a bonding force between the transition layer and the in-coupler gratings is greater than the bonding force between the reflection layer and the in-coupler gratings.

13. The electronic equipment according to claim 11, wherein the transition layer is a transparent layer.

14. The electronic equipment according to claim 13, wherein the transition layer includes an oxide layer.

15. The electronic equipment according to claim 11, wherein the transition layer includes at least one of an aluminum oxide layer or a silicon oxide layer.

16. The electronic equipment according to claim 15, wherein a thickness of the transition layer ranges from 10 nm to 50 nm.

17. The electronic equipment according to claim 15, wherein the reflection layer is a metal reflection layer or a resin reflection layer.

18. The electronic equipment according to claim 17, wherein the metal reflection layer is an Ag reflection layer or an Al reflection layer.

19. The electronic equipment according to claim 11, wherein a material of the in-coupler gratings includes one or more than two of titanium oxide, hafnium oxide, lithium niobate, titanium silicon oxide, silicon carbide, zinc selenide, indium gallium arsenic, and gallium phosphide.

20. The electronic equipment according to claim 14, wherein the transition layer includes at least one of an aluminum oxide layer or a silicon oxide layer.
